(19) United States
(12) Patent Application Publication
(10) Pub. No.: US 2014/0310538 A1
(43) Pub. Date: Oct. 16, 2014

(54) Method for Protecting Electronic Device, and Electronic Device

(71) Applicant: Huawei Device Co., Ltd., Shenzhen (CN)

(72) Inventor: Shunhai Xu, Beijing (CN)

(21) Appl. No.: 14/301,980

(22) Filed: Jun. 11, 2014

Related U.S. Application Data
(63) Continuation of application No. PCT/CN2013/076156, filed on May 23, 2013.

(30) Foreign Application Priority Data
May 25, 2012 (CN) 201210165696.4

(51) Int. Cl. G06F 1/26

(52) U.S. Cl. CPC G06F 1/26
USPC 713/300

(57) ABSTRACT

A method for protecting an electronic device, where the electronic device includes a control switch for controlling output of a power supply, and the method includes: detecting whether an exception event occurs, and if it is detected that an exception event occurs, generating a control signal for controlling the control switch; and controlling, based on the control signal, the control switch to disconnect an output channel of the power supply. Correspondingly, an embodiment of the present invention further discloses an electronic device. In embodiments of the present invention, effective shutdown can be implemented after an exception occurs on an electronic device, thereby eliminating a potential security risk that an abnormal chip of the electronic device is continuously electrified after the electronic device shuts down because of an exception event.

### CROSS-REFERENCE TO RELATED APPLICATIONS

This application is a continuation of International Application No. PCT/CN2013/076156, filed on May 23, 2013, which claims priority to Chinese Patent Application No. 201210165696.4, filed on May 25, 2012, both of which are hereby incorporated by reference in their entireties.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates to the field of electricity, and in particular, to a method for protecting an electronic device and an electronic device.

### BACKGROUND

With the development of electronic technologies, a higher requirement is imposed for protecting an electronic device in a case where an exception event occurs. At present, a method for an electronic device to handle a device exception is as follows:

An electronic device starts a shutdown process when detecting that an exception event occurs, and instructs a power management (PM) chip to power off.

However, the inventor finds that in the foregoing technology, after the electronic device shuts down because of the exception event and the PM chip powers off, a power supply (for example, an external power supply or a storage battery) of the electronic device remains in a power-on state. In this way, after the PM chip powers off, the power supply still continues to supply power to the PM chip, the PM chip is reset, the PM chip supplies power to another chip of the electronic device, and the electronic device restarts. In this way, after an exception occurs on the electronic device, effective shutdown cannot be implemented, and an abnormal chip is continuously electrified. As a result, the electronic device has a potential security risk.

### SUMMARY

Embodiments of the present invention provide a method for protecting an electronic device and an electronic device, which can implement effective shutdown after an exception occurs on an electronic device, thereby eliminating a potential security risk that an abnormal chip of the electronic device is continuously electrified after the electronic device shuts down because of an exception event.

In order to solve the foregoing technical problem, an embodiment of the present invention provides a method for protecting an electronic device, where the electronic device includes a control switch for controlling output of a power supply, and the method includes: detecting whether an exception event occurs, and if it is detected that an exception event occurs, generating a control signal for controlling the control switch; and controlling, based on the control signal, the control switch to disconnect an output channel of the power supply.

Correspondingly, an embodiment of the present invention further provides an electronic device, including: a detecting unit, a generating unit, and a controlling unit, where the controlling unit includes a control switch for controlling output of a power supply; the detecting unit is configured to detect whether an exception event occurs; the generating unit is configured to: when the detecting unit detects that an exception event occurs, generate a control signal for controlling the control switch; and the controlling unit is configured to control, based on the control signal generated by the generating unit, the control switch to disconnect an output channel of the power supply.

In the embodiments of the present invention, an electronic device detects whether an exception event occurs, and if it is detected that an exception event occurs, generates a control signal, where the control signal instructs a control switch to disconnect an output channel of a power supply. In this way, effective shutdown can be implemented after an exception occurs on the electronic device, thereby eliminating a potential security risk that an abnormal chip of the electronic device is continuously electrified after the electronic device shuts down because of an exception event.

### BRIEF DESCRIPTION OF THE DRAWINGS

To describe the technical solutions in the embodiments of the present invention or in the prior art more clearly, the following briefly introduces accompanying drawings required for describing the embodiments or the prior art. The accompanying drawings in the following description show merely some embodiments of the present invention, and a person of ordinary skill in the art may still derive other drawings from these accompanying drawings without creative efforts.

FIG. 1 is a schematic flowchart of a first embodiment of a method for protecting an electronic device according to an embodiment of the present invention;

FIG. 2 is a schematic flowchart of a second embodiment of a method for protecting an electronic device according to an embodiment of the present invention;

FIG. 3 is a schematic flowchart of a third embodiment of a method for protecting an electronic device according to an embodiment of the present invention;

FIG. 4 is a schematic structural diagram of a first embodiment of an electronic device according to an embodiment of the present invention;

FIG. 5 is a schematic structural diagram of a second embodiment of an electronic device according to an embodiment of the present invention;

FIG. 6 is a schematic structural diagram of a third embodiment of an electronic device according to an embodiment of the present invention;

FIG. 7 is a schematic structural diagram of another implementation manner of the third embodiment of the electronic device according to an embodiment of the present invention; and

FIG. 8 is a schematic structural diagram of another implementation manner of the third embodiment of the electronic device according to an embodiment of the present invention.

### DETAILED DESCRIPTION

The following clearly describes the technical solutions in the embodiments of the present invention with reference to the accompanying drawings in the embodiments of the present invention. The embodiments to be described are merely a part rather than all of the embodiments of the present invention. All other embodiments obtained by a person of ordinary skill in the art based on the embodiments of the present invention without creative efforts shall fall within the protection scope of the present invention.

FIG. 1 is a schematic flowchart of a first embodiment of a method for protecting an electronic device according to an embodiment of the present invention. In the embodiment of the present invention, the electronic device includes a control switch for controlling output of a power supply. As shown in FIG. 1, the method includes:

S101: Detect whether an exception event occurs, and if it is detected that an exception event occurs, generate a control signal for controlling the control switch.

It should be noted that an exception event may be one or more of a chip exception, unauthorized external signal input, or an exception of the power supply, where the chip exception may be an exception event such as an internal short-circuit of a chip, a temperature exception of a chip, or an abnormal power failure of a chip. Certainly, in the embodiment of the present invention, an exception event includes but is not limited to the exception events listed above. A step for the electronic device to detect whether an exception event occurs may be specifically: detecting, by a chip inside the electronic device, whether an exception event occurs, or may also be: detecting, by a watchdog circuit or baseband chip inside the electronic device, or by the power supply, whether an exception event occurs, where the detecting, by the power supply, whether an exception event occurs includes: detecting whether an exception event occurs on the power supply or detecting whether there is an unauthorized external signal input.

S102: Control, based on the control signal, the control switch to disconnect an output channel of the power supply.

It should be noted that after the output channel of the power supply is disconnected, the electronic device automatically shuts down; moreover, the power supply also cannot supply power to a PM chip or another chip. However, when the electronic device has multiple power supplies, for example, includes a primary power supply that can continue to supply power to a chip inside the electronic device after the electronic device shuts down and a backup power supply that cannot continue to supply power to the chip inside the electronic device after the electronic device shuts down, in the embodiment, the control switch included in the electronic device is a control switch for controlling output of the primary power supply, and step S102 may be specifically controlling, by the electronic device based on the control signal, the control switch to disconnect an output channel of the primary power supply. Because the electronic device has the primary power supply and the backup power supply, after the output channel of the primary power supply is disconnected, the electronic device may continue to operate with the power supplied by the backup power supply. In this way, after step S102, the method may further include starting, by the electronic device, a shutdown process.

The shutdown process is started after the output channel of the primary power supply is disconnected. In this way, after an exception event occurs on the electronic device, effective shutdown can be implemented.

If the electronic device includes multiple primary power supplies, the electronic device includes multiple control switches, where each control switch controls output of one primary power supply. In this way, step S102 may be specifically controlling, by the electronic device based on the control signal, the multiple control switches to disconnect an output channel of the primary power supplies.

In the embodiment, whether an exception event occurs is detected; and if it is detected that an exception event occurs, a control signal is generated. Based on the control signal, the control switch is controlled to disconnect an output channel of a power supply. In this way, effective shutdown can be implemented after an exception occurs on an electronic device, thereby eliminating a potential security risk that an abnormal chip of the electronic device is continuously electrified after the electronic device shuts down because of an exception event.

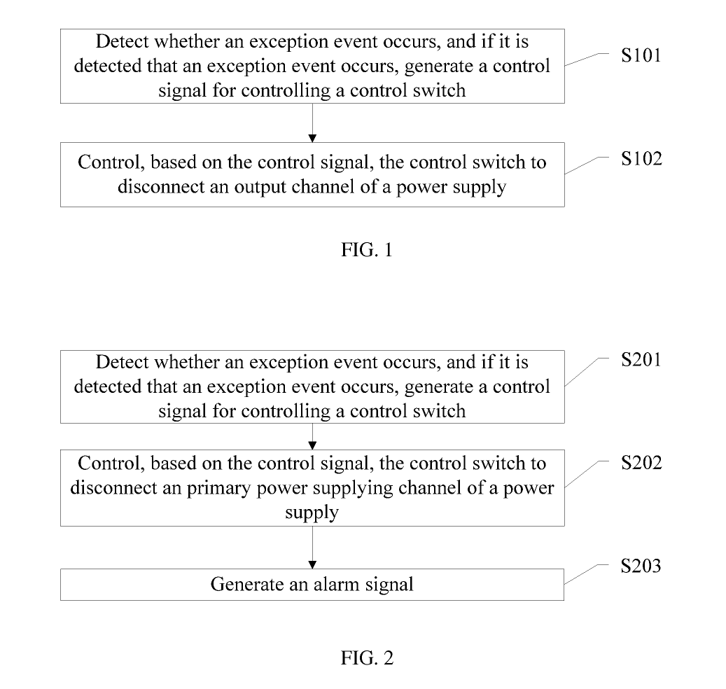

FIG. 2 is a schematic flowchart of a second embodiment of a method for protecting an electronic device according to an embodiment of the present invention. In the embodiment, a power supply of the electronic device includes two power supplying channels, that is, a primary power supplying channel and a secondary power supplying channel, where the primary power supplying channel provides a power supply required for the electronic device to operate, and the secondary power supplying channel provides a power supply required by a secondary circuit. The electronic device further includes a control switch for controlling the primary power supplying channel of the power supply. As shown in FIG. 2, the method includes:

S201: Detect whether an exception event occurs, and if it is detected that an exception event occurs, generate a control signal for controlling the control switch. Specifically, reference may be made to the description of the foregoing step S101.

S202: Control, based on the control signal, the control switch to disconnect the primary power supplying channel of the power supply.

After the primary power supplying channel of the power supply is disconnected, the electronic device automatically shuts down; moreover, the power supply also cannot supply power to a PM chip or another chip. Specifically, reference may be made to the description of the foregoing step S102.

S203: Generate an alarm signal.

An alarm signal may be specifically a prompt signal such as a sound signal or an optical signal. In this way, a user can handle an exception event that occurs in time after receiving the alarm signal. Certainly, within a period from the generating an alarm signal to the handling, by a user, an exception event that occurs, the control switch retains that the output channel of the power supply is disconnected, which prevents a chip inside the electronic device from being powered on again within the period, thereby eliminating a potential security risk.

It should be noted that the generating an alarm signal is implemented by the secondary circuit, where the secondary circuit is powered by the secondary power supplying channel of the power supply. That is, after the primary power supplying channel of the power supply is disconnected in step S202, the secondary power supplying channel of the power supply continues to supply power to the secondary circuit, and the secondary circuit generates an alarm signal.

In the embodiment, on the basis of the foregoing embodiment, a step of generating an alarm signal is added. In this way, when an exception event occurs on an electronic device and after a primary power supplying channel of a power supply is disconnected, an alarm signal may be generated, so as to instruct a user to handle the exception event in time.

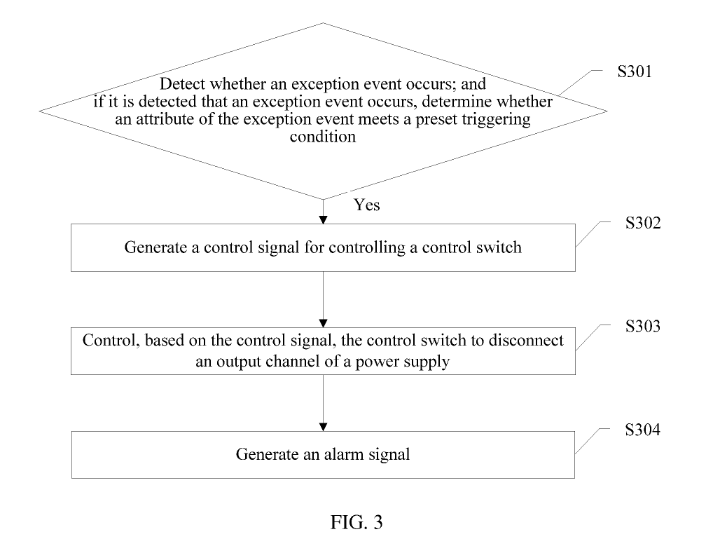

FIG. 3 is a schematic flowchart of a third embodiment of a method for protecting an electronic device according to an embodiment of the present invention. In the embodiment of the present invention, the electronic device includes a control switch for controlling output of a power supply. As shown in FIG. 3, the method includes:

S301: Detect whether an exception event occurs. If it is detected that an exception event occurs, determine whether an attribute of the exception event meets a preset triggering condition. If a determination result is yes, perform step S302; and if a determination result is no, continue to detect whether an exception event occurs. If it is detected that an exception event occurs, determine whether an attribute of the exception event meets the preset triggering condition.

It should be noted that in step S301, the determining, when the electronic device detects that an exception event occurs, whether an attribute of the exception event meets a preset triggering condition may be specifically: when the electronic device detects that an exception event occurs, detecting whether the number of times of occurrence of the exception event is larger than a preset threshold of the number of times of occurrence. The electronic device generates a control signal for controlling the control switch only when the number of times of occurrence of the exception event is larger than the preset threshold of the number of times of occurrence. Moreover, for a different electronic device, a different threshold of the number of times of occurrence of an exception event may be set according to performance of a chip inside the electronic device. That is, a different electronic device has a different triggering condition for generating a control signal for controlling the control switch. For example, a larger threshold of the number of times of occurrence of an exception event is set for a chip inside an electronic device that has higher performance. In this way, effective shutdown can be implemented after an exception occurs on the electronic device, thereby eliminating a potential security risk that an abnormal chip of the electronic device is continuously electrified after the electronic device shuts down because of an exception event, and operating efficiency of the electronic device can be further improved.

It should be noted that in another specific implementation manner, the method may further include: setting, by the electronic device, a different triggering condition for a different exception event in advance. The exception event may include one or more of a chip exception, unauthorized external signal access, or an exception of the power supply. In this way, a different triggering condition can be set for the exception event in advance. Specifically, a different triggering condition may be set according to severity of an exception event or harm on an electronic device. For example, an electronic device sets, in advance, that a triggering condition of a chip exception event is that a threshold of the number of times of occurrence is 3 times, and sets, in advance, that a triggering condition of unauthorized external signal access is that a threshold of the number of times of occurrence is 1 time, and the like, which are not fully exemplified herein. In this way, operating efficiency of the electronic device can be significantly improved.

S302: The electronic device generates a control signal for controlling the control switch.

S303: The electronic device controls, based on the control signal, the control switch to disconnect an output channel of the power supply. Specifically, reference may be made to the description of the foregoing step S102.

S304: The electronic device generates an alarm signal. Specifically, reference may be made to the description of the foregoing step S203.

In the embodiment, on the basis of the foregoing embodiment, a step of determining whether an attribute of an exception event meets a preset triggering condition is added. A control signal is generated, an output channel of a power supply is disconnected, and an alarm signal is generated only when the exception event meets the preset triggering condition. In this way, effective shutdown can be implemented after an exception occurs on the electronic device, thereby eliminating a potential security risk that an abnormal chip of the electronic device is continuously electrified after the electronic device shuts down because of an exception event, and operating efficiency of the electronic device is further improved.

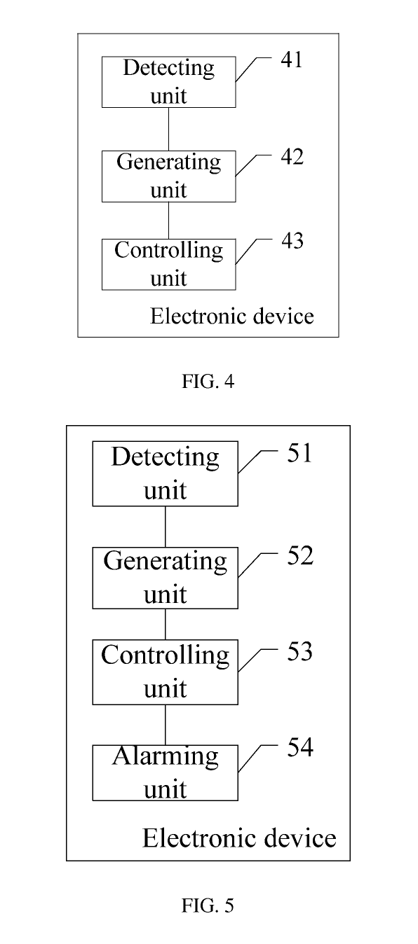

FIG. 4 is a schematic structural diagram of an electronic device according to an embodiment of the present invention. As shown in FIG. 4, the electronic device includes a detecting unit 41, a generating unit 42, and a controlling unit 43, where the controlling unit 43 includes a control switch for controlling output of a power supply.

The detecting unit 41 is configured to detect whether an exception event occurs.

It should be noted that an exception event may be one or more of a chip exception, unauthorized external signal access, or an exception of the power supply, where the chip exception may be an exception event such as an internal short-circuit of a chip, a temperature exception of a chip, or an abnormal power failure of a chip. Certainly, in the embodiment of the present invention, an exception event includes but is not limited to the exception events listed above.

The generating unit 42 is configured to: when the detecting unit 41 detects that an exception event occurs, generate a control signal for controlling the control switch.

It should be noted that in a specific implementation manner, the control switch may be specifically a field-effect transistor, where the field-effect transistor is connected between the power supply and a PM chip. After the electronic device is powered on, the generating unit 42 generates one control signal for controlling connection of the field-effect transistor, so that the power supply supplies power to the PM chip, and the electronic device enters an operating state. When the detecting unit 41 detects an exception event, the generating unit 42 generates one control signal for controlling disconnection of the field-effect transistor, thereby disconnecting a channel for the power supply to supply power to the PM chip and stopping supplying power to the PM chip, and the electronic device shuts down.

The controlling unit 43 is configured to control, based on the control signal generated by the generating unit 42, the control switch to disconnect an output channel of the power supply.

It should be noted that after the controlling unit 43 controls the control switch to disconnect the output channel of the power supply, the electronic device automatically shuts down; moreover, the power supply also cannot supply power to the PM chip or another chip. However, when the electronic device has multiple power supplies, for example, includes a primary power supply that can continue to supply power to a chip inside the electronic device after the electronic device shuts down and a backup power supply that cannot continue to supply power to a chip inside the electronic device after the electronic device shuts down, in the embodiment, the control switch in the controlling unit 43 is a control switch for controlling output of the primary power supply, and the controlling unit 43 is further configured to control, based on the control signal generated by the generating unit, the control switch to disconnect an output channel of the primary power supply.

Because the electronic device has the primary power supply and the backup power supply, after the output channel of the primary power supply is disconnected, the electronic device may continue to operate with the power supplied by the backup power supply. In this way, the electronic device may further include a shutdown unit configured to start a shutdown process after the controlling unit 43 controls the control switch to disconnect the output channel of the power supply.

The shutdown process is started after the output channel of the primary power supply is disconnected. In this way, effective shutdown can be implemented after an exception event occurs on the electronic device. Certainly, because of a cause such as the amount of electricity stored in the backup power supply, after the electronic device starts the switch, the backup power supply cannot supply power to the PM chip or another chip.

In the embodiment, a detecting unit detects whether an exception event occurs; when the detecting unit detects that an exception event occurs, a generating unit generates a control signal; and a controlling unit controls, based on the control signal generated by the generating unit, a control switch to disconnect an output channel of a power supply. In this way, effective shutdown can be implemented after an exception occurs on the electronic device, thereby eliminating a potential security risk that an abnormal chip of the electronic device is continuously electrified after the electronic device shuts down because of an exception event.

FIG. 5 is a schematic structural diagram of a second embodiment of an electronic device according to an embodiment of the present invention. In the embodiment, a power supply of the electronic device includes two power supplying channels, that is, a primary power supplying channel and a secondary power supplying channel, where the primary power supplying channel provides a power supply required for the electronic device to operate, and the secondary power supplying channel provides a power supply required by an alarming unit. As shown in FIG. 5, the electronic device includes a detecting unit 51, a generating unit 52, a controlling unit 53, and an alarming unit 54, where the controlling unit 53 includes a control switch for controlling output of the power supply.

The detecting unit 51 is configured to detect whether an exception event occurs. Specifically, reference may be made to the description of the foregoing detecting unit 41.

The generating unit 52 is configured to: when the detecting unit 51 detects that an exception event occurs, generate a control signal for controlling the control switch. Specifically, reference may be made to the description of the foregoing generating unit 42.

The controlling unit 53 is configured to control, based on the control signal generated by the generating unit 52, the control switch to disconnect the primary power supplying channel of the power supply. Specifically, reference may be made to the description of the foregoing controlling unit 43.

The alarming unit 54 is configured to generate an alarm signal after the controlling unit 53 disconnects the output channel of the power supply.

An alarm signal may be specifically a prompt signal such as a sound signal or an optical signal. In this way, a user can handle an exception event that occurs in time after receiving the alarm signal. Certainly, within a period from the generating an alarm signal to the handling, by a user, an exception event that occurs, the control switch retains that the output channel of the power supply is disconnected, which prevents a chip inside the electronic device from being powered on again within the period, thereby eliminating a potential security risk.

It should be noted that the alarming unit 54 is powered by the secondary power supplying channel of the power supply. That is, after the controlling unit 53 disconnects the primary power supplying channel of the power supply, the secondary power supplying channel of the power supply continues to supply power to the alarming unit 54, and the alarming unit 54 generates an alarm signal.

In the embodiment, on the basis of the foregoing embodiment, an alarming unit is added. In this way, when an exception event occurs on an electronic device and after a primary power supplying channel of a power supply is disconnected, an alarm signal may be generated, so as to instruct a user to handle the exception event in time.

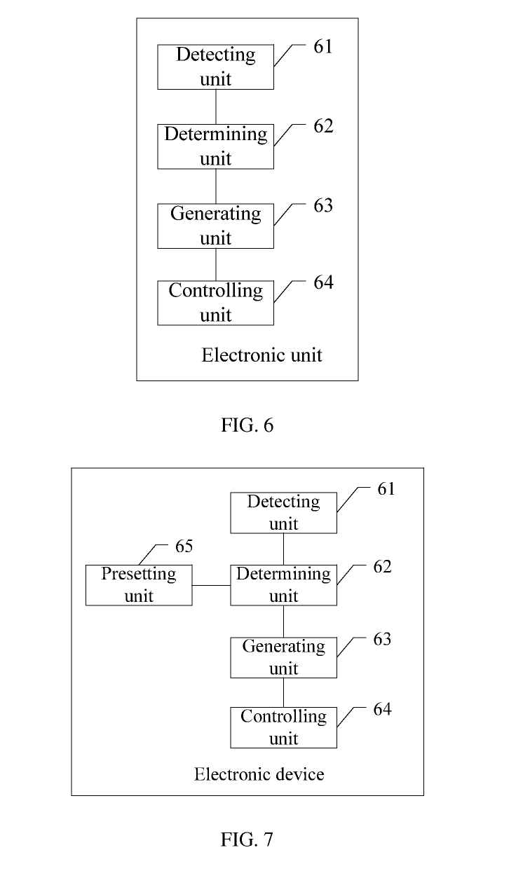

FIG. 6 is a schematic structural diagram of a third embodiment of an electronic device according to an embodiment of the present invention. As shown in FIG. 6, the electronic device includes a detecting unit 61, a determining unit 62, a generating unit 63, and a controlling unit 64, where the controlling unit 63 includes a control switch for controlling output of a power supply.

The detecting unit 61 is configured to detect whether an exception event occurs. Specifically, reference may be made to the description of the foregoing detecting unit 41.

The determining unit 62 is configured to: when the detecting unit 61 detects that an exception event occurs, determine whether an attribute of the exception event meets a preset triggering condition, and if a determination result is yes, instruct the generating unit 63 to generate a control signal for controlling the control switch. In this way, the generating unit 63 generates a control signal for controlling the control switch only when an exception event that occurs meets the preset triggering condition, so that the electronic device performs a protection action for the exception event that occurs, and operating efficiency of the electronic device can also be improved.

Specifically, the determining unit 62 is further configured to: when the detecting unit 61 detects that an exception event occurs, determine whether the number of times of occurrence of the exception event is larger than a preset threshold of the number of times of occurrence, and if a determination result is yes, instruct the generating unit 63 to generate a control signal for controlling the control switch.

The electronic device generates a control signal for controlling the control switch only when the number of times of occurrence of the exception event is larger than the preset threshold of the number of times of occurrence. In this way, effective shutdown can be implemented after an exception occurs on the electronic device, thereby eliminating a potential security risk that an abnormal chip of the electronic device is continuously electrified after the electronic device shuts down because of an exception event, and operating efficiency of the electronic device can be further improved.

The generating unit 63 is configured to: when the determining unit 62 determines that an attribute of the exception event meets the preset triggering condition, generate a control signal for controlling the control switch. Specifically, reference may be made to the description of the foregoing generating unit 42.

The controlling unit 64 is configured to control, based on the control signal generated by the generating unit 63, the control switch to disconnect a primary power supplying channel of the power supply. Specifically, reference may be made to the description of the foregoing controlling unit 43.

It should be noted that, as shown in FIG. 7, in another implementation manner, the electronic device may further include: a presetting unit 65 configured to set a different triggering condition for a different exception event in advance; and the determining unit 62 is further configured to: when the detecting unit 61 detects that an exception event occurs, determine whether an attribute of the exception event meets a triggering condition that is set by the presetting unit 65 for the exception event in advance, and if a determination result is yes, instruct the generating unit to generate a control signal for controlling the control switch.

Specifically, the presetting unit 65 may set a different triggering condition according to severity of an exception event or harm on an electronic device. For example, the presetting unit 65 sets, in advance, that a triggering condition of a chip exception event is that a threshold of the number of times of occurrence is 3 times, and sets, in advance, that a triggering condition of unauthorized external signal access is that a threshold of the number of times of occurrence is 1 time, and the like, which are not fully exemplified herein. In this way, operating efficiency of the electronic device can be significantly improved.

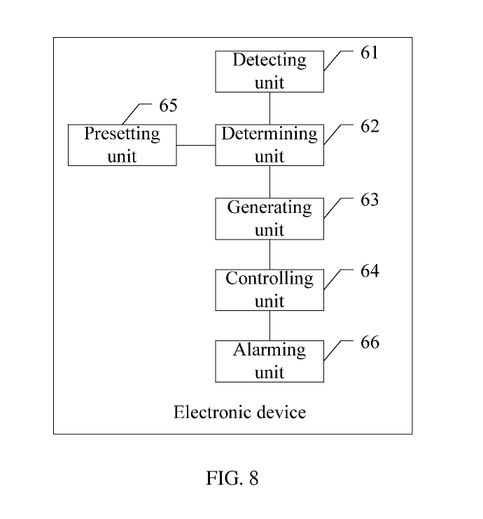

It should be noted that, as shown in FIG. 8, in another implementation manner, the electronic device may further include: an alarming unit 66 configured to generate an alarm signal after the controlling unit 63 disconnects the output channel of the power supply. Specifically, reference may be made to the description of the foregoing controlling unit 54.

In the embodiment, on the basis of the foregoing embodiment, a determining unit is added. A control signal is generated, and an output channel of a power supply is disconnected only when an exception event meets a preset triggering condition. In this way, effective shutdown can be implemented after an exception occurs on an electronic device, thereby eliminating a potential security risk that an abnormal chip of the electronic device is continuously electrified after the electronic device shuts down because of an exception event, and operating efficiency of the electronic device can be further improved.

The foregoing description is merely exemplary embodiments of the present invention, but is not intended to limit the scope of the claims of the present invention. Therefore, equivalent changes made according to the claims of the present invention shall fall within the scope of the present invention.

What is claimed is:

1. A method for protecting an electronic device, wherein the electronic device comprises a control switch for controlling output of a power supply, and the method comprises:
detecting whether an exception event occurs;
generating a control signal for controlling the control switch when it is detected that the exception event occurs; and
controlling, based on the control signal, the control switch to disconnect an output channel of the power supply.

2. The method according to claim 1, wherein the electronic device comprises a primary power supply that continues to supply power to a chip inside the electronic device after the electronic device shuts down, and a backup power supply that cannot continue to supply power to a chip inside the electronic device after the electronic device shuts down, wherein the control switch is a control switch for controlling output of the primary power supply, and wherein controlling, based on the control signal, the control switch to disconnect an output channel of the power supply is specifically controlling, based on the control signal, the control switch to disconnect an output channel of the primary power supply.

3. The method according to claim 2, wherein after controlling, based on the control signal, the control switch to disconnect the output channel of the primary power supply, the method further comprises starting a shutdown process.

4. The method according to claim 1, wherein after it is detected that the exception event occurs and before generating the control signal for controlling the control switch, the method further comprises:
determining whether an attribute of the exception event meets a preset triggering condition; and
triggering generating, by the electronic device, the control signal for controlling the control switch when the attribute of the exception event meets the preset triggering condition.

5. The method according to claim 4, wherein the method further comprises setting a different triggering condition for a different exception event in advance, and wherein determining whether the attribute of the exception event meets the preset triggering condition is specifically determining whether the attribute of the exception event meets a triggering condition that is set for the exception event in advance.

6. The method according to claim 4, wherein determining whether the attribute of the exception event meets the preset triggering condition is specifically determining whether the number of times of occurrence of the exception event is larger than a preset threshold of the number of times of occurrence.

7. The method according to claim 1, wherein the exception event comprises one or more of a chip exception, unauthorized external signal access, or an exception of the power supply.

8. The method according to claim 1, wherein after controlling, based on the control signal, the control switch to disconnect the output channel of the power supply, the method further comprises generating an alarm signal.

9. An electronic device, comprising:
a detecting unit;
a generating unit; and
a controlling unit,
wherein the controlling unit comprises a control switch for controlling output of a power supply,
wherein the detecting unit is configured to detect whether an exception event occurs,
wherein the generating unit is configured to generate a control signal for controlling the control switch when the detecting unit detects than an exception event occurs, and
wherein the controlling unit is configured to control, based on the control signal generated by the generating unit, the control switch to disconnect an output channel of the power supply.

10. The electronic device according to claim 9, wherein when the electronic device comprises a primary power supply that can continue to supply power to a chip inside the electronic device after the electronic device shuts down, and a backup power supply that cannot continue to supply power to a chip inside the electronic device after the electronic device shuts down, wherein the control switch is a control switch for controlling output of the primary power supply, and wherein the controlling unit is further configured to control, based on the control signal generated by the generating unit, the control switch to disconnect an output channel of the primary power supply.

11. The electronic device according to claim 10, wherein the electronic device further comprises a shutdown unit configured to start a shutdown process after the controlling unit controls the control switch to disconnect the output channel of the power supply.

12. The electronic device according to claim 9, wherein the electronic device further comprises a determining unit configured to:
determine whether an attribute of an exception event meets a preset triggering condition when the detecting unit detects that the exception event occurs; and
instruct the generating unit to generate a control signal for controlling the control switch when the attribute of the exception event meets the preset triggering condition.

13. The electronic device according to claim 12, wherein the electronic device further comprises a presetting unit configured to set a different triggering condition for a different exception event in advance, and wherein the determining unit is further configured to:
determine whether an attribute of an exception event meets a triggering condition that is set by the presetting unit for the exception event in advance when the detecting unit detects that the exception event occurs; and
instruct the generating unit to generate a control signal for controlling the control switch when the attribute of the exception event meets the triggering condition that is set by presetting unit for the exception event in advance.

14. The electronic device according to claim 12, wherein the determining unit is further configured to:
determine whether the number of times of occurrence of the exception event is larger than a preset threshold of the number of times of occurrence when the detecting unit detects that the exception event occurs; and
instruct the generating unit to generate a control signal for controlling the control switch when the number of times of occurrence of the exception event is larger than the preset threshold of the number of times of occurrence.

15. The electronic device according to claim 9, wherein the exception event comprises one or more of a chip exception, unauthorized external signal access, or an exception of the power supply.

16. The electronic device according to claim 9, wherein the electronic device further comprises an alarming unit configured to generate an alarm signal after the controlling unit disconnects the output channel of the power supply.
